(19) United States
(12) Patent Application Publication
(10) Pub. No.: US 2024/0402863 A1
(43) Pub. Date: Dec. 5, 2024

(54) Adjusting Windows on a Display

(71) Applicant: Apple Inc., Cupertino, CA (US)

(72) Inventors: Aviv Miron, Santa Clara, CA (US); Thomas D. Finch, San Francisco, CA (US); Michael E. Buerli, San Francisco, CA (US); Mark L. Ma, San Francisco, CA (US)

(21) Appl. No.: 18/650,465

(22) Filed: Apr. 30, 2024

Related U.S. Application Data
(60) Provisional application No. 63/506,085, filed on Jun. 4, 2023.

(51) Int. Cl. G06F 3/0481; G06F 3/04842

(52) U.S. Cl. CPC G06F 3/0481; G06F 3/04842

(57) ABSTRACT

An electronic device may include a display that simultaneously presents multiple windows. A graph data structure may be stored to efficiently track overlap between windows on the display. Overlapping windows on the display may be grouped into window groups. For each window group, at least one of the windows may be set as a focused window and the remaining windows may be set as defocused windows. Rendering of the defocused window may be adjusted relative to rendering of the focused window. A defocused window may be rendered with a lower resolution than the focused window, may be rendered with a lower opacity than the focused window, and/or at a lower frame rate than the focused window.

This application claims the benefit of U.S. provisional patent application No. 63/506,085 filed Jun. 4, 2023, which is hereby incorporated by reference herein in its entirety.

### BACKGROUND

This relates generally to electronic devices, and, more particularly, to electronic devices with displays.

Some electronic devices include displays that simultaneously present multiple windows. If care is not taken, the windows may obscure one another. If care is not taken, displaying the windows may take more processing power than desired.

### SUMMARY

A method of operating an electronic device with a display may include grouping multiple windows on the display into a window group, setting at least one window of the multiple windows in the window group as a focused window for the window group and setting at least one remaining window of the multiple windows in the window group as a defocused window, and adjusting rendering of the defocused window relative to the focused window.

A method of operating an electronic device with a display may include simultaneously presenting multiple windows on the display including a first window for an application, rendering the first window using a first magnitude for a property while the first window is a focused window, and rendering the first window using a second magnitude for the property that is different than the first magnitude in response to the first window changing from the focused window to a defocused window.

A method of operating an electronic device with a display may include simultaneously presenting multiple windows on the display, storing a graph data structure that represents overlap between the multiple windows on the display, adding a new window to the display, determining whether the new window overlaps any of the multiple windows on the display, and updating the graph data structure to represent overlap between the new window and the multiple windows on the display.

### BRIEF DESCRIPTION OF THE DRAWINGS

FIG. 1 is a schematic diagram of an illustrative electronic device in accordance with some embodiments.

FIG. 2A is a diagram of multiple windows on an illustrative display in accordance with some embodiments.

FIG. 2B is a diagram of a graph data structure that represents the windows on the illustrative display of FIG. 2A in accordance with some embodiments.

FIG. 3A is a diagram of the multiple windows of FIG. 2A after one of the windows is moved in accordance with some embodiments.

FIG. 3B is a diagram of a graph data structure that represents the windows on the illustrative display of FIG. 3A in accordance with some embodiments.

FIG. 4 is a diagram of an illustrative electronic device with a central renderer for simultaneously displaying windows from multiple applications in accordance with some embodiments.

FIG. 5 is a flowchart of an illustrative method for updating a graph data structure associated with multiple windows on a display in accordance with some embodiments.

FIG. 6 is a flowchart of an illustrative method for adjusting rendering of a defocused window relative to a focused window in accordance with some embodiments.

FIG. 7 is a flowchart of an illustrative method for rendering a window with a different magnitude for a property when the window is a focused window then when the window is a defocused window in accordance with some embodiments.

### DETAILED DESCRIPTION

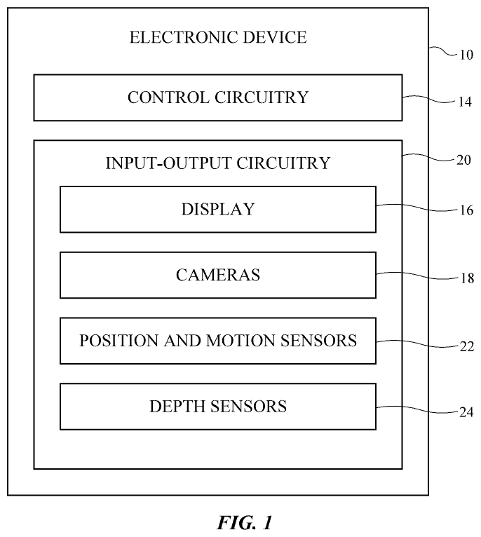

An illustrative electronic device is shown in FIG. 1. Electronic device 10 may be a computing device such as a laptop computer, a computer monitor containing an embedded computer, a tablet computer, a cellular telephone, a media player, or other handheld or portable electronic device, a smaller device such as a wrist-watch device, a pendant device, a headphone or earpiece device, a device embedded in eyeglasses or other equipment worn on a user's head, or other wearable or miniature device, a display, a computer display that contains an embedded computer, a computer display that does not contain an embedded computer, a gaming device, a navigation device, an embedded system such as a system in which electronic equipment with a display is mounted in a kiosk or automobile, or other electronic equipment. Electronic device 10 may have the shape of a pair of eyeglasses (e.g., supporting frames), may form a housing having a helmet shape, or may have other configurations to help in mounting and securing the components of one or more displays on the head or near the eye of a user.

As shown in FIG. 1, electronic device 10 (sometimes referred to as head-mounted device 10, system 10, head-mounted display 10, etc.) may have control circuitry 14. Control circuitry 14 may be configured to perform operations in electronic device 10 using hardware (e.g., dedicated hardware or circuitry), firmware and/or software. Software code for performing operations in electronic device 10 and other data is stored on non-transitory computer readable storage media (e.g., tangible computer readable storage media) in control circuitry 14. The software code may sometimes be referred to as software, data, program instructions, instructions, or code. The non-transitory computer readable storage media (sometimes referred to generally as memory) may include non-volatile memory such as non-volatile random-access memory (NVRAM), one or more hard drives (e.g., magnetic drives or solid-state drives), one or more removable flash drives or other removable media, or the like. Software stored on the non-transitory computer readable storage media may be executed on the processing circuitry of control circuitry 14. The processing circuitry may include application-specific integrated circuits with processing circuitry, one or more microprocessors, digital signal processors, graphics processing units, a central processing unit (CPU) or other processing circuitry.

Electronic device 10 may include input-output circuitry 20. Input-output circuitry 20 may be used to allow data to be received by electronic device 10 from external equipment (e.g., a tethered computer, a portable device such as a handheld device or laptop computer, or other electrical equipment) and to allow a user to provide electronic device 10 with user input. Input-output circuitry 20 may also be used to gather information on the environment in which electronic device 10 is operating. Output components in circuitry 20 may allow electronic device 10 to provide a user with output and may be used to communicate with external electrical equipment.

As shown in FIG. 1, input-output circuitry 20 may include a display such as display 16. Display 16 may be used to display images for a user of electronic device 10. Display 16 may be a transparent display so that a user may observe physical objects through the display while computer-generated content is overlaid on top of the physical objects by presenting computer-generated images on the display. A transparent display may be formed from a transparent pixel array (e.g., a transparent organic light-emitting diode display panel) or may be formed by a display device that provides images to a user through a beam splitter, holographic coupler, or other optical coupler (e.g., a display device such as a liquid crystal on silicon display). Alternatively, display 16 may be an opaque display that blocks light from physical objects when a user operates electronic device 10. In this type of arrangement, a pass-through camera may be used to display physical objects to the user. The pass-through camera may capture images of the physical environment and the physical environment images may be displayed on the display for viewing by the user. Additional computer-generated content (e.g., text, game-content, other visual content, etc.) may optionally be overlaid over the physical environment images to provide an extended reality environment for the user. When display 16 is opaque, the display may also optionally display entirely computer-generated content (e.g., without displaying images of the physical environment).

Display 16 may include one or more optical systems (e.g., lenses) (sometimes referred to as optical assemblies) that allow a viewer to view images on display(s) 16. A single display 16 may produce images for both eyes or a pair of displays 16 may be used to display images. In configurations with multiple displays (e.g., left and right eye displays), the focal length and positions of the lenses may be selected so that any gap present between the displays will not be visible to a user (e.g., so that the images of the left and right displays overlap or merge seamlessly). Display modules (sometimes referred to as display assemblies) that generate different images for the left and right eyes of the user may be referred to as stereoscopic displays. The stereoscopic displays may be capable of presenting two-dimensional content (e.g., a user notification with text) and three-dimensional content (e.g., a simulation of a physical object such as a cube).

Input-output circuitry 20 may include various other input-output devices. For example, input-output circuitry 20 may include one or more cameras 18. Cameras 18 may include one or more outward-facing cameras (that face the physical environment around the user when the electronic device is mounted on the user's head, as one example). Cameras 18 may capture visible light images, infrared images, or images of any other desired type. The cameras may be stereo cameras if desired. Outward-facing cameras may capture pass-through video for device 10.

As shown in FIG. 1, input-output circuitry 20 may include position and motion sensors 22 (e.g., compasses, gyroscopes, accelerometers, and/or other devices for monitoring the location, orientation, and movement of electronic device 10, satellite navigation system circuitry such as Global Positioning System circuitry for monitoring user location, etc.). Using sensors 22, for example, control circuitry 14 can monitor the current direction in which a user's head is oriented relative to the surrounding environment (e.g., a user's head pose). The outward-facing cameras in cameras 18 may also be considered part of position and motion sensors 22. The outward-facing cameras may be used for face tracking (e.g., by capturing images of the user's jaw, mouth, etc. while the device is worn on the head of the user), body tracking (e.g., by capturing images of the user's torso, arms, hands, legs, etc. while the device is worn on the head of user), and/or for localization (e.g., using visual odometry, visual inertial odometry, or other simultaneous localization and mapping (SLAM) technique).

Input-output circuitry 20 may include one or more depth sensors 24. Each depth sensor may be a pixelated depth sensor (e.g., that is configured to measure multiple depths across the physical environment) or a point sensor (that is configured to measure a single depth in the physical environment). Each depth sensor (whether a pixelated depth sensor or a point sensor) may use phase detection (e.g., phase detection autofocus pixel(s)) or light detection and ranging (LIDAR) to measure depth. Any combination of depth sensors may be used to determine the depth of physical objects in the physical environment.

Input-output circuitry 20 may also include other sensors and input-output components if desired (e.g., gaze tracking sensors, ambient light sensors, force sensors, temperature sensors, touch sensors, image sensors for detecting hand gestures or body poses, buttons, capacitive proximity sensors, light-based proximity sensors, other proximity sensors, strain gauges, gas sensors, pressure sensors, moisture sensors, magnetic sensors, microphones, speakers, audio components, haptic output devices such as actuators, light-emitting diodes, other light sources, wired and/or wireless communications circuitry, etc.).

During operation of electronic device 10, display 16 may be used to simultaneously present multiple windows. Each window may include display content associated with a respective application, as one illustrative example. The windows may be presented for the user within a three-dimensional environment. When display 16 is opaque, the windows may be presented within a three-dimensional environment over a computer-generated virtual background and/or over a pass-through video representing the user's physical environment. When display 16 is transparent, the windows may be presented over the physical environment that is also visible through the transparent display.

When the windows are presented in a three-dimensional environment, each window may be presented at a corresponding depth (e.g., the perceived distance from the user when viewed by the user). Different windows may have different depths.

When multiple windows are displayed, the windows may or may not overlap with one another when viewed from the perspective of the user. When multiple windows overlap with one another, a composite image of the overlapping image may be presented. The windows may have encoded opacity values that determine how opaque or transparent a foreground window appears when overlaid over a background. For example, when a foreground window has an opacity of 0, the foreground image is entirely transparent and the composite image matches the background image. When a foreground window has an opacity of 1, the foreground image is entirely opaque and the composite image matches the foreground image.

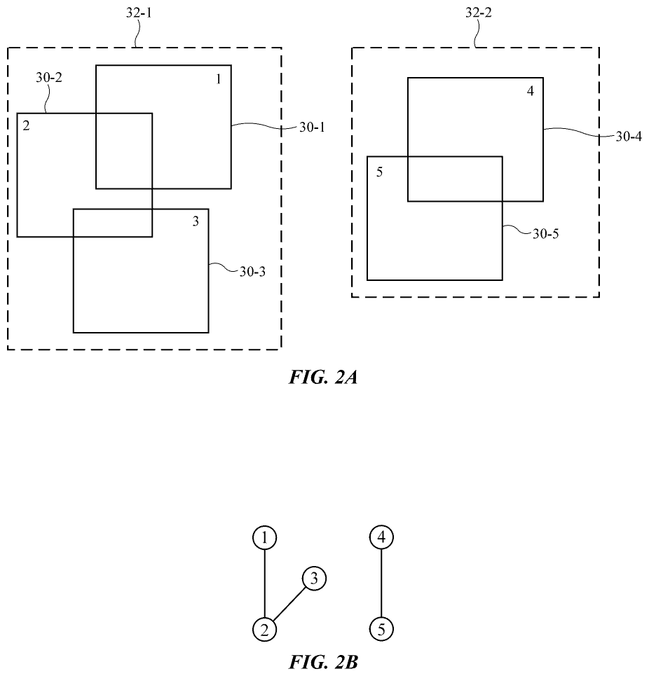

FIG. 2A is a diagram of multiple windows being displayed on display 16. In the example of FIG. 2A, there are 5 windows being simultaneously displayed: window 30-1, window 30-2, window 30-3, window 30-4, and window 30-5. Windows 30-1 and 30-2 are overlapping, windows 30-2 and 30-3 are overlapping, and windows 30-4 and 30-5 are overlapping.

Within control circuitry 14, the overlapping relationships between the windows may be represented by a graph data structure, as shown in FIG. 2B. Herein, each node in the graph data structure represents a respective window. Each edge (e.g., a line between nodes) in the graph data structure connects represents an overlap between the two windows corresponding to the nodes connected by that edge. The nodes in the graph data structure may sometimes be referred to as vertices. As shown in FIG. 2B, nodes 1 and 2 are connected by an edge representing the overlap between windows 1 and 2. Nodes 2 and 3 are connected by an edge representing the overlap between windows 2 and 3. Nodes 4 and 5 are connected by an edge representing the overlap between windows 4 and 5. The absence of additional edges indicates that no other two windows on the display are overlapping.

Windows that are overlapping may be grouped together into a window group. If either of the windows in that window group overlap an additional window, the additional window will also be included in the window group. A window that overlaps any window in the window group is included in the window group. In other words, each window group includes at least two overlapping windows and all of the windows that overlap at least one of the windows in that window group.

The windows of FIG. 2A are arranged in two window groups: a first window group 32-1 that includes windows 30-1, 30-2, and 30-3 and a second window group 32-2 that includes windows 30-4 and 30-5.

For each window group, at least one of the windows may be identified as the focused window for that window group and the remaining windows may be identified as defocused windows for that window group. Having at least one focused window for each window group may improve the user experience when multiple windows are overlapping. In general, exactly one window of the windows may be selected as the focused window and the remaining windows may be identified as defocused windows. However, there are exceptions where multiple windows may simultaneously be focused windows. As one example, when entering text into a window using a virtual keyboard, both the window and the virtual keyboard may be focused windows even when the window and the virtual keyboard are overlapping.

There are many ways to select which window in a window group is the focused window. When a window is initially opened, it may be the focused window for its window group. When a window is being repositioned, it may be the focused window for its window group. When a window is being manually or automatically resized, it may be the focused window for its window group. If a drag-and-drop action is performed where an element is dropped in a given window, the given window may be selected as the focused window.

A user may provide input to manually select one window of a window group as the focused window. The user input may include a hand gesture, gaze input, audio input, and/or input to an input component such as a trackpad, button, touch sensor, etc. The hand gesture may be a pinch gesture or other gesture that selects a window as the focused window for the window group. If the user's gaze lingers on a window for longer than a threshold dwell time, that window may be set to be the focused window for the window group. The user may provide a voice command (e.g., detected by a microphone) selecting a window as the focused window for the window group. The user may use one or more input components to hover and/or click a cursor to select a window as the focused window for the window group.

Different types of content may have different priorities when determining which window is a focused window out of a window group. To assess which window should be the focused window in the window group, each window may have a corresponding focus score. In one possible convention, a higher focus score may indicate a higher priority for that window to be the focused window whereas a lower focus score may indicate a lower priority for that window to be the focused window.

Examples of windows that may have a relatively high priority in determining the focused window include windows associated with a heads-up display interface, windows associated with a home screen user interface for the electronic device, windows associated with accessibility functionality (e.g., voice over, switch control, etc.), windows associated with collecting user input such as a window presenting a keyboard, windows associated with a virtual assistant, etc. In general, any desired order may be used for the priority of various types of content and these priorities may be changed by the user if desired.

The focused window may remain the focused window unless usurped by an additional window. For example, consider an example where the windows are presented in a three-dimensional environment but do not all fit in the user's field of view. The user may look back and forth between window group 32-1 and window 32-2. In this example, window 30-1 is the focused window for window group 32-1 and window 30-4 is the focused window for window group 32-2. The user may look at window group 32-2 and observe window 30-4 (which is a focused window) and window 30-5 (which is a defocused window). The user may then turn their gaze towards window group 32-1 and observe window 30-1 (which is a focused window) and windows 30-2 and 30-3 (which are defocused windows). While looking at window group 32-1, the user cannot see window group 32-2. However, the positioning of window group 32-2 and the focus status of each window in window group 32-2 is stored in control circuitry 14. Thus, when the user looks back at window group 32-2, the user may observe window 30-4 (which is still the focused window) and window 30-5 (which is still a defocused window). The focus status of each window is therefore persistent in the absence of other adjustments.

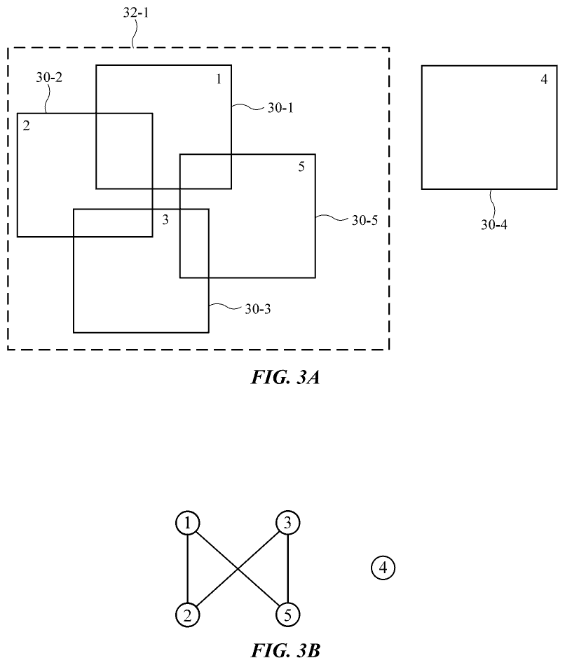

FIG. 3A shows an example where window 30-5 is moved to the left from window group 32-2 to window group 32-1. In the new position of FIG. 3A, window 30-5 overlaps windows 30-1 and 30-3. The change in the position of window 30-5 is reflected in the graph data structure of FIG. 3B. As shown in FIG. 3B, nodes 1 and 2 are connected by an edge representing the overlap between windows 1 and 2. Nodes 2 and 3 are connected by an edge representing the overlap between windows 2 and 3. Nodes 1 and 5 are connected by an edge representing the overlap between windows 1 and 5. Nodes 3 and 5 are connected by an edge representing the overlap between windows 3 and 5.

In connection with FIG. 2A, an example was described where windows 30-4 and 30-1 were the focused windows. Continuing that example, when window 30-5 is selected for repositioning, window 30-5 may become the focused window for window group 32-2 instead of window 30-4. In other words, before window 30-5 is repositioned, window 30-4 is the focused window and window 30-5 is the defocused window. After window 30-5 is selected for repositioning (and while windows 30-4 and 30-5 still overlap), window 30-4 is the defocused window and window 30-5 is the focused window.

Before window 30-5 overlaps cither window 30-1 or window 30-3, window 30-1 may remain the focused window for window group 32-1. However, once window 30-5 overlaps either window 30-1 or 30-3 as in FIG. 3A, window 30-5 becomes a part of window group 32-1. Because window 30-5 is being repositioned, it is the focused window of window group 32-1 and window 30-1 is changed to become a defocused window. In other words, while window 30-5 is being repositioned and before window 30-5 overlaps cither window 30-1 or window 30-3, window 30-1 is the focused window and windows 30-2 and 30-3 are defocused windows. While window 30-5 is being repositioned and while window 30-5 overlaps either window 30-1 or window 30-3, window 30-5 is the focused window and windows 30-1, 30-2, and 30-3 are defocused windows.

The graph data structure of FIGS. 2B and 3B may be built and maintained over time as various windows are opened, closed, resized, and repositioned on display 16. Each time any window is manipulated, an overlap algorithm may be applied to the given window to determine overlap between the given window and any additional windows present in the user's environment. When the windows are positioned in a three-dimensional environment, each window may be positioned with six degrees of freedom. The overlap algorithm may be configured to determine whether windows are overlapping in the three-dimensional environment (factoring in the depth of each window and the head position of the user). Because the overlap algorithm only needs to be applied to the window being manipulated, there may be sufficient processing power budget available to apply the overlap algorithm continuously to the window that is being manipulated.

As an example, initially there may be no windows opened and the graph data structure is blank (null). The first window is opened and the first node corresponding to the first window is added to the graph data structure. The second window is opened and the second node corresponding to the second window is added to the graph data structure. After the second window is opened, the overlap algorithm may be applied to the second window to determine if the second window is overlapping with the first window. In the example of FIGS. 2A and 2B, an edge is applied to the graph data structure between the first and second nodes indicating that the first and second windows are indeed overlapping. The third window is opened and the third node corresponding to the third window is added to the graph data structure. After the third window is opened, the overlap algorithm may be applied to the third window to determine if the third window is overlapping with the first or second windows. In the example of FIGS. 2A and 2B, an edge is applied to the graph data structure between the second and third nodes indicating that the second and third windows are overlapping. The fourth window is opened and the fourth node corresponding to the fourth window is added to the graph data structure. After the fourth window is opened, the overlap algorithm may be applied to the fourth window to determine if the third window is overlapping with the first, second, or third windows. In the example of FIGS. 2A and 2B, the fourth window is not overlapping the first, second, or third windows so no additional edges are added to the graph data structure. The fifth window is opened and the fifth node corresponding to the fifth window is added to the graph data structure. After the fifth window is opened, the overlap algorithm may be applied to the fifth window to determine if the fifth window is overlapping with the first, second, third, or fourth windows. In the example of FIGS. 2A and 2B, an edge is applied to the graph data structure between the fourth and fifth nodes indicating that the fourth and fifth windows are overlapping.

When a window is repositioned (e.g., when the fifth window is repositioned as between FIG. 2A in FIG. 3A), the overlap algorithm may be applied only to the window that is being repositioned. For example, the overlap algorithm may be applied to window 30-5 while window 30-5 is moved from the position in FIG. 2A to the position in FIG. 3A. When window 30-5 is determined to no longer be overlapping window 30-4, the edge between the fourth and fifth nodes of the graph data structure is removed. Subsequently, when window 30-5 is determined to be overlapping window 30-1, an edge is added between the first and fifth nodes of the graph data structure. Subsequently, when window 30-5 is determined to be overlapping window 30-3, an edge is added between the third and fifth nodes of the graph data structure.

Maintaining the graph data structure in this manner may be an efficient way to track overlap between windows. Using a persistent graph data structure enables the overlap algorithm to only be applied to new windows and windows that are being repositioned and/or resized. The overlap algorithm does not need to be applied to static windows in the system. This provides processing power savings relative to an arrangement where the overlap algorithm is consistently applied to all of the windows.

To improve user comfort when multiple windows are simultaneously presented on display 16, the opacity of each focused window may be high (so that the focused window dominates the composite image of the multiple windows) whereas the opacity of each defocused window may be low. The low opacity of the defocused windows may allow for the content of the defocused windows to still be visible to the user without undesired obstruction of or distraction from the focused window. The opacity of the defocused window may be non-zero, allowing the user to see the content of the defocused window and change one of the defocused windows to a focused window if desired. Displaying the image with low opacity may also result in power consumption improvements in some arrangements. Even if the defocused window has a closer depth than the focused window, the relatively low opacity of the defocused window and the relatively high opacity of the focused window allows for the focused window to be easily viewable.

In general, any desired adjustments may be made when rendering a defocused window relative to rendering a focused window. As previously mentioned, a defocused window may be rendered with a lower opacity than a focused window. Other rendering adjustments to a defocused window include rendering the defocused window at a lower frame rate than the focused window, rendering the defocused window at a lower resolution than the focused window, shutting down an application associated with the defocused window (e.g., by snapshotting the latest rendered content of the defocused window, storing the snapshot as a texture in memory, unloading the application from memory, and displaying the snapshot as an interim placeholder for actively rendered content from the application), sending an instruction to an application associated with the defocused window that limits a rate for window updates by the application, sending an instruction to an application associated with the defocused window indicating that the application is using a defocused window, sending an instruction to an application associated with the defocused window to reduce power consumption, etc.

The depiction in FIGS. 2A and 3A of each window as having a rectangular footprint is merely illustrative. In general, each window may have any desired footprint (e.g., circular, rectangular, an irregular shape, etc.). Additionally, windows may be defined as non-continuous if desired. For example, a single window (sometimes referred to as a window volume) may have a main window volume plus some additional window volumes (sometimes referred to as ornaments) that are logically linked to that window volume but not necessarily within the physical bounds of that main window volume. When a window is defocused, some or all of the ornaments for that window may be omitted (e.g., leaving only the main window volume).

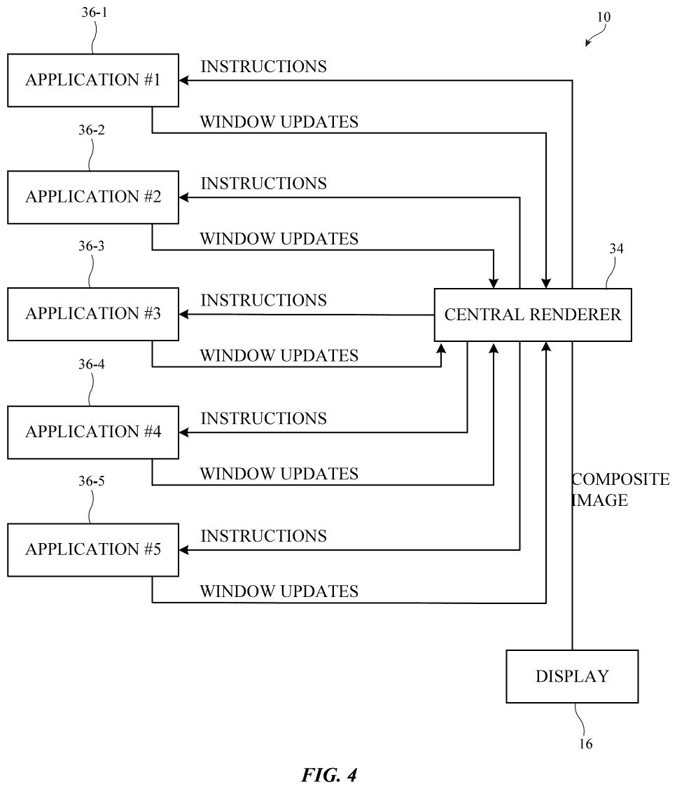

FIG. 4 is a schematic diagram of an illustrative electronic device with a display. As shown in FIG. 4, electronic device 10 may include a central renderer 34. Central renderer 34 may receive information from multiple sources and output a composite image to be presented on display 16. The central renderer may receive information from one or more applications. In the example of FIG. 4, the central renderer receives information from applications 36-1, 36-2, 36-3, 36-4, and 36-5. Application 36-1 provides content to be presented at window 30-1 in FIGS. 2A and 3A, application 36-2 provides content to be presented at window 30-2 in FIGS. 2A and 3A, application 36-3 provides content to be presented at window 30-3 in FIGS. 2A and 3A, application 36-4 provides content to be presented at window 30-4 in FIGS. 2A and 3A, and application 36-5 provides content to be presented at window 30-5 in FIGS. 2A and 3A. Central renderer 34 may also receive content from an operating system for device 10 and/or from a pass-through video feed (e.g., from camera 18 in FIG. 1). If desired, additional downstream circuitry may be included to combine a composite image from the central renderer with additional images (e.g., a pass-through video feed). The central renderer may use the received content to output a composite image that is presented on display 16 (or merged with other content that is then presented on display 16).

In this example, each application has one corresponding window. The application may provide content that is intended to be displayed on the window for that application (labeled as ‘window updates’ in FIG. 4). Each application need not know the size, location, or focus state of its corresponding window to provide window updates to central renderer 34. Each application simply provides target window updates for its corresponding window, and central renderer 34 subsequently sizes and positions each window in the resulting composite image.

It is noted that the 1:1 correlation between applications and windows in FIG. 4 is merely illustrative. In some arrangements a single application may control multiple windows and/or multiple applications may combine to control a single window.

In general, display 16 may operate with a frame rate (sometimes referred to as a refresh rate). The frame rate may be 60 Hz, 90 Hz, 120 Hz, 150 Hz, 240 Hz, more than 60 Hz, less than 300 Hz, or any other desired frame rate. The composite image may be provided to display 16 at a rate that is equal to the frame rate, as one example.

In one illustrative arrangement, central renderer may update each window for each display frame. Consider an example where the frame rate of display 16 is 120 Hz. Each application may provide window updates at 120 Hz. Each window in the composite image may be updated at 120 Hz. Central renderer 34 may output composite images at 120 Hz.

To reduce power consumption, one or more of the windows may be updated at a frequency that is lower than the frame rate for the display. The update frequency may be throttled at the application side (e.g., the rate at which the application provides window updates) and/or at the central renderer side (e.g., the rate at which the central renderer uses the window updates to update the window in the composite image).

Consider the example of FIG. 2A, where windows 30-1 and 30-4 are focused windows and windows 30-2, 30-3, and 30-5 are defocused windows. Central renderer 34 may update windows 30-1 and 30-4 at 120 Hz. However, the defocused windows 30-2, 30-3, and 30-5 may be updated by central renderer 34 at a lower rate (e.g., 30 Hz) to conserve processing power. This is one example of adjusting the rendering of the defocused windows relative to the rendering of the focused windows.

As shown in FIG. 4, central renderer 34 may also send instructions to one or more of the applications 36. As an example, the central renderer may send instructions to applications 36-2, 36-3, and 36-5 (which respectively control the defocused windows 30-2, 30-3, and 30-5) to reduce the rate at which the applications provide window updates (e.g., from 120 Hz to 30 Hz). This is another example of adjusting the rendering of the defocused windows relative to the rendering of the focused windows.

To conserve processing power, central renderer 34 may render defocused windows at a lower resolution than the focused windows. Central renderer 34 may send instructions to a corresponding application limiting the resolution of the content provided via the window updates. Alternatively, the central renderer 34 may render the defocused windows at a lower resolution than the focused windows even when the display content provided via the window updates is the same for the focused and defocused windows.

In one possible arrangement, central renderer 34 may send an instruction to an application to shut down the application when the window for that application has been defocused for longer than a threshold duration of time. When the application is shut down, the window for that application may still be presented on display 16 in a defocused state (e.g., with a low opacity). The image presented for that image may be a static two-dimensional image (e.g., a snapshot of the application before the application was closed). If the window is subsequently selected and becomes a focused window, the application for that window may be reopened and begin to provide window updates.

Other instructions that may be provided by central renderer to the applications include an instruction indicating that the application is using a defocused window. The application may then make corresponding adjustments to the resolution of the content provided, to the frequency at which window updates are provided, to the opacity of the content provided, etc.

The central renderer may also send an instruction to an application associated with the defocused window to reduce power consumption. The application may then make corresponding adjustments to the resolution of the content provided, to the frequency at which window updates are provided, to the opacity of the content provided, etc.

In general, central renderer 34 may send any desired instructions to an application based on the focus state of the window for that application. When central renderer 34 sends instructions to an application to reduce the magnitude of a property (e.g., resolution, power consumption, update frequency, opacity, etc.), the central renderer may include a maximum allowable magnitude for that property, may send a target magnitude for that property, and/or may send a general instruction to reduce the magnitude for that property (without specifying a specific amount).

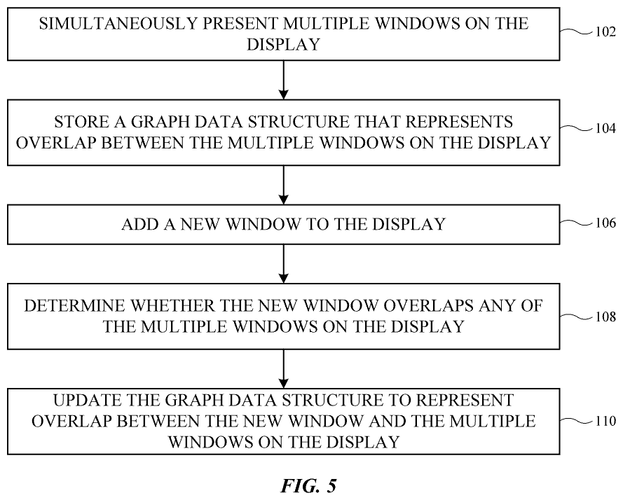

FIG. 5 is a flowchart showing an illustrative method performed by an electronic device (e.g., control circuitry 14 and/or central renderer 34 in device 10). The blocks of FIG. 5 may be stored as instructions in memory of electronic device 10, with the instructions configured to be executed by one or more processors in the electronic device.

During the operations of block 102, control circuitry 14 may simultaneously present multiple windows on display 16. Each window may have a corresponding application that provides the content for that window. The windows may be presented at various positions within a user's three-dimensional environment. The windows may have different depths.

During the operations of block 104, control circuitry 14 may store a graph data structure that represents overlap between the multiple windows on the display. The graph data structure may be generated and maintained by determining overlap between any new windows added to the graph data structure and windows already present in the graph data structure. Each node in the graph data structure corresponds to a window and each edge in the graph data structure represents overlap between the two nodes to which it is connected.

The example of using a graph data structure to represent the overlap between windows on the display is merely illustrative. In general, any desired type of data may be generated and stored to represent overlap between windows on the display.

During the operations of block 106, a new window may be added to the display. The new window may be added to the display when, for example, a new application is launched by the user.

During the operations of block 108, an overlap algorithm may be used to determine whether the new window overlaps any of the multiple windows that are already present on the display. The overlap algorithm may factor in the locations of the windows in the three-dimensional environment to determine whether the windows overlap from the perspective of the user. When the windows overlap in the three-dimensional environment from the perspective of the user, the windows may be referred to as overlapping on display 16.

During the operations of block 110, control circuitry 14 may update the graph data structure (e.g., from block 104) to represent overlap between the new window and the multiple windows on the display. For example, a node may be added to the graph data structure that represents the new window. An edge may be added between the node for the new window and any windows that the new window overlaps.

After the graph data structure is updated, the graph data structure may be used to group the windows into one or more window groups. Specifically, the graph data structure may be traversed, and all connected nodes may be grouped into a respective window group. Each window group may have at least one focused window. The remaining window(s) in each window group are defocused windows.

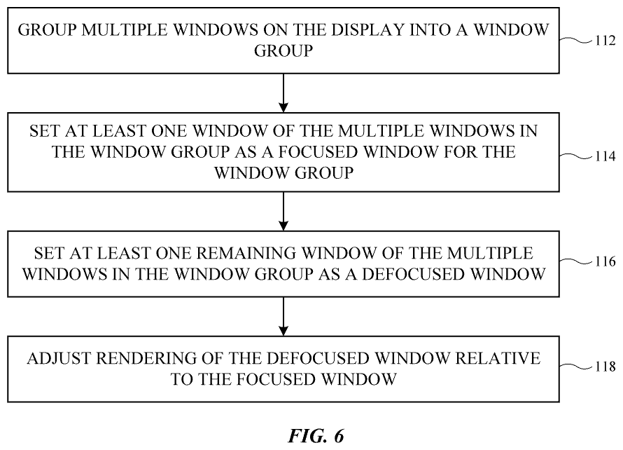

FIG. 6 is a flowchart showing an illustrative method performed by an electronic device (e.g., control circuitry 14 and/or central renderer 34 in device 10). The blocks of FIG. 6 may be stored as instructions in memory of electronic device 10, with the instructions configured to be executed by one or more processors in the electronic device.

During the operations of block 112, control circuitry 14 may group multiple windows on the display into at least one window group. The window groups may be determined, for example, using a graph data structure (as shown in FIGS. 2B and 3B). Each window group includes at least two overlapping windows and includes all windows overlapping any other window in the window group.

During the operations of block 114, control circuitry 14 may set at least one window of the multiple windows in a window group as a focused window for that window group. The focused window(s) may be the most recently launched window, a window selected by a hand gesture, voice command, gaze input, or other user input, the most recently repositioned window, the most recently resized window, a window with high priority content, etc. In general, any desired criteria may be used to determine which window in a window group is the focused window.

During the operations of block 116, the control circuitry may set the remaining windows of the multiple windows in the window group (from block 114) as defocused windows. At least one window in each window group is a focused window, with the remaining windows being defocused windows. In some situations, exactly one window in each group may be a focused window.

During the operations of block 118, the control circuitry may adjust rendering of the defocused window(s) relative to the focused window in a window group. Adjusting the rendering of the defocused windows may include rendering the defocused window at a lower frame rate than the focused window (e.g., by implementing window updates from a corresponding application less frequently for the defocused window than for the focused window and/or by sending an instruction to an application associated with the defocused window that limits a rate for window updates performed and/or sent by the application), rendering the defocused window at a lower opacity than the focused window, rendering the defocused window at a lower resolution than the focused window, rendering the defocused window with only a main window volume (e.g., omitting some or all ornaments associated with that window), shutting down an application associated with the defocused window and displaying a static snapshot from the application at the defocused window, sending an instruction to an application associated with the defocused window indicating that the application is using a defocused window, sending an instruction to an application associated with the defocused window to reduce opacity, resolution, and/or update rate, and/or sending an instruction to an application associated with the defocused window to reduce power consumption. Any desired subset of these adjustments may be made to each defocused window in the window group. The adjustments to the defocused window may conserve processing power and/or power consumption.

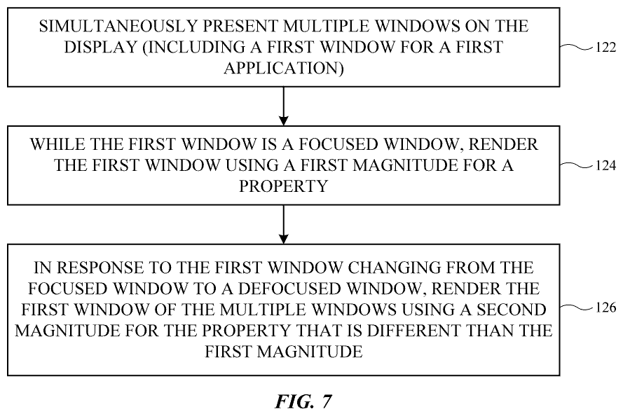

FIG. 7 is a flowchart showing an illustrative method performed by an electronic device (e.g., control circuitry 14 and/or central renderer 34 in device 10). The blocks of FIG. 7 may be stored as instructions in memory of electronic device 10, with the instructions configured to be executed by one or more processors in the electronic device.

During the operations of block 122, control circuitry may simultaneously display multiple windows on the display. Each window may have a corresponding application that provides the content for that window. The windows may be presented at various positions within a user's three-dimensional environment. The windows may have different depths. The windows displayed at block 122 may include a first window for a first application that is running on electronic device 10.

During the operations of block 124, while the first window is a focused window, the first window may be rendered using a first magnitude for a property. The property may be resolution, transparency, opacity, a rate of updates from the first application, or any other desired property.

During the operations of block 126, in response to the first window changing from the focused window to a defocused window, the first window may be rendered using a second magnitude for the property. The second magnitude may be different than (e.g., less than or greater than) the first magnitude.

Consider an example where the property in blocks 124 and 126 is resolution. The first window may be rendered with a first resolution at block 124 while the first window is a focused window and may be rendered with a second resolution that is lower than the first resolution at block 126 while the first window is a defocused window.

Consider an example where the property in blocks 124 and 126 is opacity. The first window may be rendered with a first opacity at block 124 while the first window is a focused window and may be rendered with a second opacity that is lower than the first opacity at block 126 while the first window is a defocused window.

Consider an example where the property in blocks 124 and 126 is transparency. The first window may be rendered with a first transparency at block 124 while the first window is a focused window and may be rendered with a second transparency that is higher than the first transparency at block 126 while the first window is a defocused window.

Consider an example where the property in blocks 124 and 126 is the rate of updates (e.g., window updates) from the first application. The window updates may be received at a first frequency at block 124 while the first window is a focused window and may be received at a second frequency that is less than the first frequency at block 126 while the first window is a defocused window.

As yet another example, the property in blocks 124 and 126 may be a rate at which the window updates are implemented to the window of the composite image (e.g., by central renderer 34). The window may be updated (rendered) at a first frequency at block 124 while the first window is a focused window and may be updated (rendered) at a second frequency that is less than the first frequency at block 126 while the first window is a defocused window.

The first window may change from being a focused window to a defocused window at block 126 in response to being repositioned, resized, selected using user input, etc. After the operations of block 126, the window may be changed back to a focused window and the rendering of the first window may revert back to using the first magnitude for the property (as in the operations of block 124).

The foregoing is merely illustrative and various modifications can be made to the described embodiments. The foregoing embodiments may be implemented individually or in any combination.

What is claimed is:

1. A method of operating an electronic device with a display;
grouping multiple windows on the display into a window group;
setting at least one window of the multiple windows in the window group as a focused window for the window group and setting at least one remaining window of the multiple windows in the window group as a defocused window; and
adjusting rendering of the defocused window relative to the focused window.

2. The method defined in claim 1, wherein adjusting the rendering of the defocused window relative to the focused window comprises rendering the defocused window at a lower frame rate than the focused window.

3. The method defined in claim 2, wherein rendering the defocused window at the lower frame rate than the focused window comprises implementing window updates from a corresponding application less frequently for the defocused window than for the focused window.

4. The method defined in claim 1, wherein adjusting the rendering of the defocused window relative to the focused window comprises performing an action selected from the group consisting of: rendering the defocused window at a lower opacity than the focused window, rendering the defocused window at a lower resolution than the focused window, and shutting down an application associated with the defocused window.

5. The method defined in claim 4, wherein adjusting the rendering of the defocused window relative to the focused window comprises displaying a static snapshot from the application at the defocused window.

6. The method defined in claim 1, wherein adjusting the rendering of the defocused window relative to the focused window comprises sending an instruction to an application associated with the defocused window that limits a rate for window updates by the application.

7. The method defined in claim 1, wherein adjusting the rendering of the defocused window relative to the focused window comprises sending an instruction to an application associated with the defocused window indicating that the application is using a defocused window.

8. The method defined in claim 1, wherein adjusting the rendering of the defocused window relative to the focused window comprises sending an instruction to an application associated with the defocused window to reduce power consumption.

9. The method defined in claim 1, further comprising:
storing a graph data structure that represents overlap between the multiple windows on the display, wherein grouping the multiple windows on the display into the window group comprises grouping the multiple windows on the display into the window group using the graph data structure.

10. The method defined in claim 1, wherein setting the at least one window of the multiple windows in the window group as the focused window comprises setting the at least one window of the multiple windows in the window group as the focused window in response to user input.

11. The method defined in claim 1, wherein setting the at least one window of the multiple windows in the window group as the focused window comprises setting the at least one window of the multiple windows in the window group as the focused window in response to the at least one window being repositioned.

12. The method defined in claim 1, wherein setting the at least one window of the multiple windows in the window group as the focused window comprises setting the at least one window of the multiple windows in the window group as the focused window in response to the at least one window being resized.

13. The method defined in claim 1, wherein setting the at least one window of the multiple windows in the window group as the focused window comprises setting the at least one window of the multiple windows in the window group as the focused window based on a respective focus score for each one of the multiple windows.

14. The method defined in claim 1, further comprising:
grouping additional windows on the display into an additional window group; and
setting at least one window of the additional windows in the additional window group as an additional focused window for the additional window group.

15. A method of operating an electronic device with a display;
simultaneously presenting multiple windows on the display, wherein the multiple windows include a first window for an application;
while the first window is a focused window, rendering the first window using a first magnitude for a property; and
in response to the first window changing from the focused window to a defocused window, rendering the first window using a second magnitude for the property that is different than the first magnitude.

16. The method defined in claim 15, wherein the property comprises a property selected from the group consisting of: a resolution, a transparency, and a rate of updates from the application.

17. The method defined in claim 15, further comprising:
storing a graph data structure that represents overlap between the multiple windows on the display.

18. A method of operating an electronic device with a display;
simultaneously presenting multiple windows on the display;
storing a graph data structure that represents overlap between the multiple windows on the display;
adding a new window to the display;
determining whether the new window overlaps any of the multiple windows on the display; and
updating the graph data structure to represent overlap between the new window and the multiple windows on the display.

19. The method defined in claim 18, further comprising:
using the graph data structure, grouping the multiple windows into at least two window groups.

20. The method defined in claim 19, further comprising:
selecting one focused window for each window group of the at least two window groups.
